(19) United States
(12) Patent Application Publication
(10) Pub. No.: US 2013/0132289 A1
(43) Pub. Date: May 23, 2013

(54) OIL AND GAS INTEREST TRACKING SYSTEM

(71) Applicant: EquityMetrix, LLC, Dallas, TX (US)

(72) Inventors: Frank D. Agnew, Metairie, LA (US); Thomas J. Agnew, Dallas, TX (US)

(73) Assignee: EquityMetrix, LLC, Dallas, TX (US)

(21) Appl. No.: 13/668,989

(22) Filed: Nov. 5, 2012

Related U.S. Application Data
(60) Provisional application No. 61/555,561, filed on Nov. 4, 2011.

(51) Int. Cl. G06Q 50/16

(52) U.S. Cl. CPC G06Q 50/16
USPC 705/313

(57) ABSTRACT

A system for managing oil and gas mineral interest comprising: a server; one or more databases operatively associated with the server for storing oil and gas mineral interest data; one or more computer terminals operatively associated with the server and the database; an owner registration module operatively associated with the server and the database; a beneficiary registration module operatively associated with the server and the database; an access control module operatively associated with the server and the database; an oil and gas mineral interest data registration module operatively associated with the server and the database; a data standardization module operatively associated with the server and the database; an update module operatively associated with the server and the database; and a surveillance process module operatively associated with the server and the database.

### RELATED CASES

This application claims the priority of the provisional application Ser. No. 61/555,561 filed on Nov. 4, 2011.

### FIELD OF THE INVENTION

The present invention relates to a management system for tracking oil and gas mineral interests over time.

### BACKGROUND OF THE INVENTION

The management and transfer of oil and gas mineral interests has traditionally been handled through the physical transfer of paper documents including deeds, leases, contracts, assignments, etc. Each time an oil and gas mineral interest was transferred from one owner and/or beneficiary to another, a set of additional paper documents is drafted, signed and stored with the previous documents in the oil and gas mineral interest chain of title. There are many significant drawbacks to this archaic method of interest transfer. First and foremost is the vast amount of space required to physically store all of the boxes which contain the chains of title. Another significant problem is associated with the misplacement or loss of documents from within the chains of title which result in a gap in the chain of title. The misplacement and loss of documents results in title defects, loss of revenue and unnecessary litigation. This method also makes searching and verification of an owner's or a beneficiary's oil and gas mineral interest extremely difficult as one or more boxes must be physically searched in order to locate and confirm an interest. It also means that the person or persons conducting the search must travel to the sole location of the files.

In light of all of the inadequacies detailed above, it is clear that a need exists to provide a more efficient and search friendly method of managing the oil and gas mineral interests of owners and/or beneficiaries.

### SUMMARY OF THE INVENTION

A system for managing an oil and gas mineral interest comprising: a server; one or more databases operatively associated with the server for storing oil and gas mineral interest data; one or more computer terminals operatively associated with the server and the database; an owner registration module operatively associated with the server and the database which is used to register the owner and provide the owner access to the system; a beneficiary registration module operatively associated with the server and the database which is used to register the beneficiary and provide the beneficiary access to the system; an access control module operatively associated with the server and the database which is used to grant one or more levels of access to owners and/or beneficiaries to the system; an oil and gas mineral interest data registration module operatively associated with the server and the database; a data standardization module operatively associated with the server and the database which grants a standard number and standard organizational theme to a copy of each entry of oil and gas mineral interest data entered into the system; an update module operatively associated with the server and the database which allows for the updating of oil and gas mineral interest data; and a surveillance process module operatively associated with the server and the database which allows for the monitoring of owner and/or beneficiary oil and gas mineral interest data.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an illustration of one embodiment of the present invention.

FIG. 2 is an illustration of one embodiment of the present invention.

FIG. 3 is an illustration of one embodiment of the present invention.

FIG. 4 is an illustration of one embodiment of the QSIPP generated tag from the present invention.

FIG. 5 illustrates some of the tags utilized by the present invention.

FIG. 6 is an illustration of one embodiment of a process of the present invention.

### DETAILED DESCRIPTION

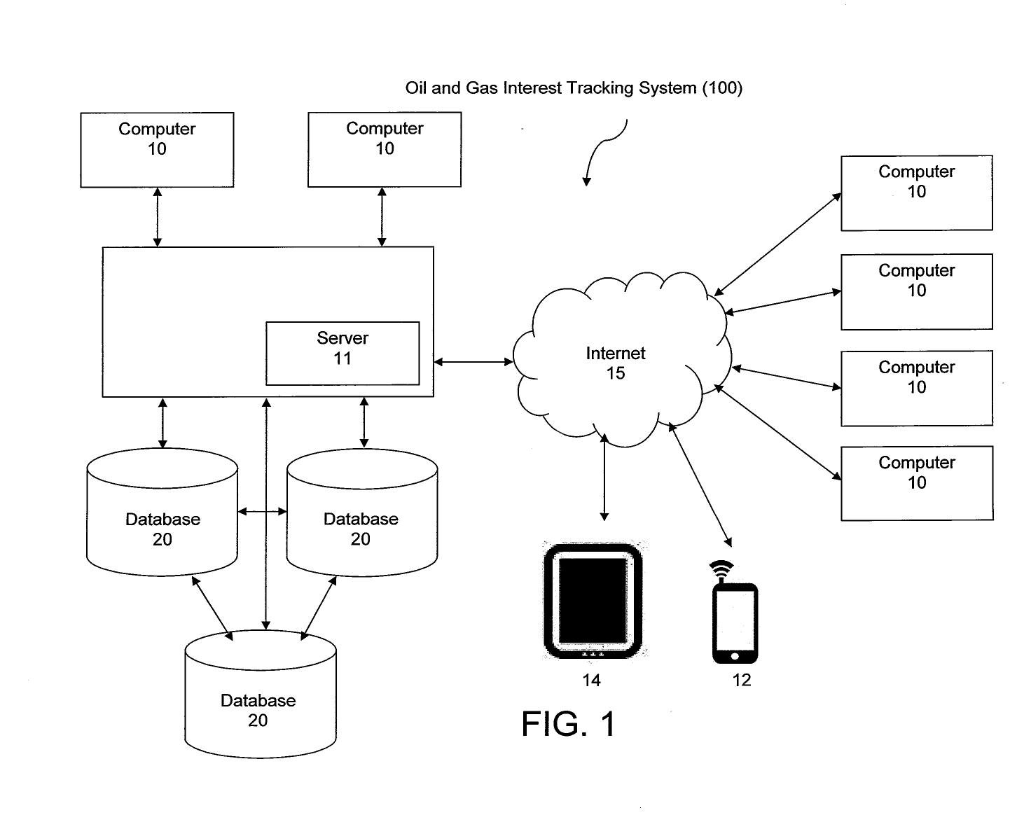

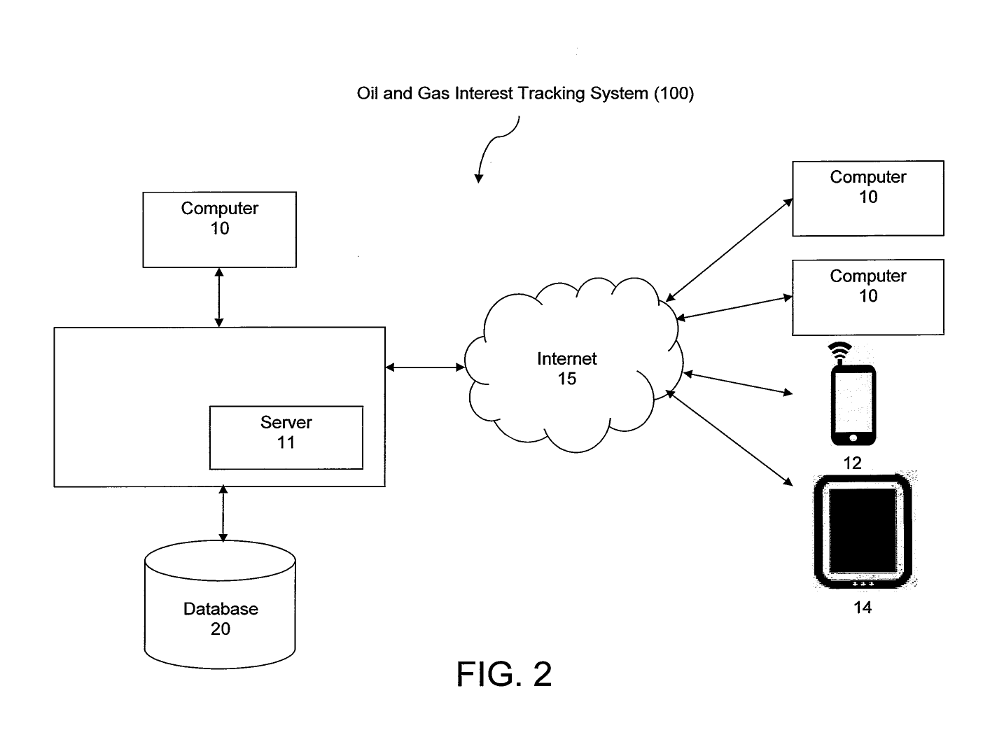

The instant invention involves a system 100 (FIGS. 1-3) and a method for storing oil and gas mineral interest data and tracking over an extended period of time. The system 100 further includes a server 11, one or more databases 20 operatively associated with the server and one or more computer terminals 10 operatively associated with the server 11 and the database 20. The system 100 may be implemented physically on a specific site, or it may be implemented through cloud computing. Cloud computing, as used herein, describes the use of computing resources (i.e., software, hardware, etc.) which are delivered as a service over a network such as the internet 15. Cloud computing allows one or more users to entrust remote services with that user's data, software and hardware. The cloud computing model may include a variety of delivery methods including, but not limited to, a public cloud, a community cloud, a private cloud, or a combination thereof.

Server 11, as used herein, describes a computer or a series of computers, which link the system 100 for storing oil and gas mineral interest data together. Servers 11 within this system function as understood by those having skill in the art. A server 11 may be a computer dedicated to run one or more services, to serve the needs of the various users of other computers on the network. The server 11 may be selected from the group including an application server, a database server, a file server, a proxy server, a remote access server, a standalone server, or a combination thereof. The one or more servers 11 which are dedicated to running the system 100 including all of the modules associated with the system. The server 11 may be a computer 10 or a series of computers, which link the system for storing oil and gas mineral interest data together. Servers 11 within this system function as understood by those having skill in the art. In one embodiment of the present invention, one or more of the servers 11 are a remote access server which permits a user to access the server and/or the one or more databases operatively associated with the server for storing oil and gas mineral interest data from a remote location over an open or a closed computer network or the internet.

Database 20, as described herein, refers to an organized collection of data which is stored within or on some form of computer readable storage medium (i.e., a hard drive, flash drive, magnetic storage medium, optical disk etc.). The data is often organized according to a particular data structure which defines the manner of storing and organizing data within the actual database. A database 20 may be thought of as an organized pool of related data and that data is stored within the data structures of the database. The database 20 may be a single database or a plurality of databases which are operatively associated with one another. A database 20 may be selected from the group including, but not limited to, an active database, a distributed database, a cloud database, a document oriented database, an embedded database, an end-user database or a combination thereof. The data stored within the database(s) 20 may include digital document images, digital representations of maps, extracts of data describing mineral interests, data entered into or generated by any and all of the modules associated with the Oil and Gas Interest Tracking System 100 described within this application.

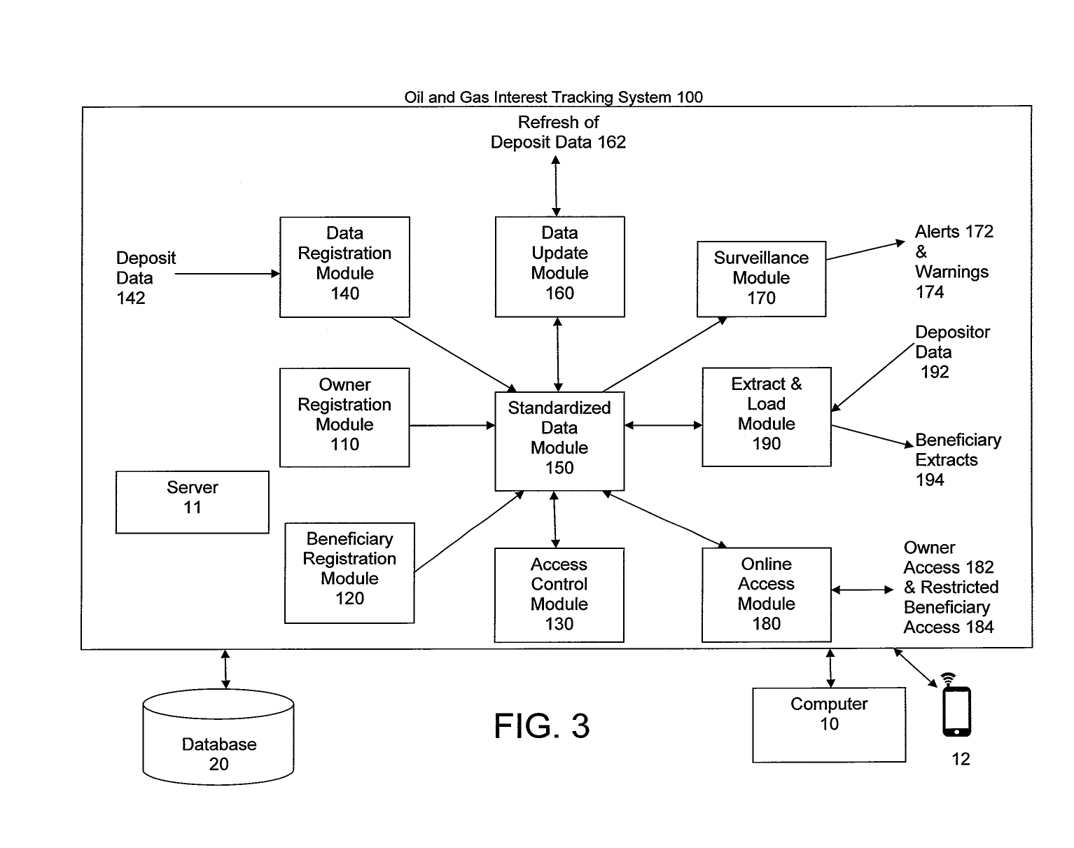

Computer terminal 10, as described herein, refers to a device which is well known in the art. A computer terminal 10 may include a personal computer, a general purpose computer, a workstation, a smart phone 12, a tablet 14, or a combination thereof. Looking to FIG. 1, an embodiment illustrates a computer terminal which may be operated remotely from the system, gaining access to the system through the internet 15. The same Figure illustrates that a tablet 14 (i.e., Amazon Kindle, Apple iPad, Samsun Galaxy, etc.) or smart phone 12 (iPhone, Blackberry, Droid Razr, etc.) may be used by an owner, a depositor and/or a beneficiary to gain access to the system 100. FIG. 3 also illustrates a computer terminal 10 connected directly to the system. The various types of computer terminals 10 may access the system directly (i.e., an intranet connection), or remotely through the use of an internet browser (i.e., Microsoft Internet Explorer, Mozilla Firefox, Google Chrome, a remote desktop connection, etc.).

Mineral interest, as used herein, refers to any interest that one or more individuals or entities (corporations, partnerships, etc.) has in a mineral. Mineral, as used herein, is used as a generic term to cover any material produced from the earth or the ocean. In one embodiment, mineral refers to crude oil and/or natural gas produced from a wellhead. Owner, as used herein, refers to the individual or entity that owns the rights to receive value for the mineral produced from a wellhead. An owner may also be known as a depositor. A depositor refers to one or more individuals or entities who may deposit data into the oil and gas interest tracking system. Operator, as used herein, refers to an entity responsible to the owner for producing and selling the mineral produced from the wellhead. Working interest owner, as used herein, refers to an entity in a contractual arrangement with an operator to share in the cost, volumes, and sales of the mineral produced from the wellhead. Transporter, as used herein, refers to the entity that performs gathering and transportation services to deliver the mineral produced from the wellhead to the purchaser. Processor, as used herein, refers to an entity that processes certain types of minerals to extract additional products from the mineral produced from the wellhead. Marketer, as used herein, refers to an entity that sells, either on an agency or principal basis, the mineral produced from the wellhead on behalf of the operator or working interest owner. Purchaser, as used herein, refers to an entity that purchases the mineral produced from the wellhead and typically interacts with the any seller: e.g., operator, working interest owner, or marketer.

The system 100 includes a plurality of modules which may be utilized by users of the system and altered by the administrators of the system. The modules may be accessed either at the computer terminal 10 or online through an intranet 15 or through the internet using a computer terminal 10, a tablet 14, a smart phone 12 or any other device known in the art which may be used to access a computer system remotely. The system 100 includes an owner registration module 110 operatively associated with the server 11 and the database 20 which is used to register the owner and provide the owner access to the system 100. The owner registration module 110 is intended to grant access to the system to the owner of a mineral interest. The module 110 will record and maintain mineral owner information. The owner registration module 110 may include a mineral owner identification number; the owner's name and address; the name and address of an owner's agent, trustee, designee, administrator, executor, or the like (if applicable); the owner's state and federal tax identification numbers; estate/probate history; escheat history; owner's deposit instructions; and other owner contact information. Other fields may be added hereto as deemed appropriate. In one embodiment of the present invention, the mineral owner registration module 110 may grant a mineral owner full access to all documentation stored within the system related to that owner's interests. In another embodiment of the present invention, the mineral owner registration module may grant a mineral owner limited access to all documentation stored within the system related to that owner's interests.

The system further includes a beneficiary registration 120 module operatively associated with the server 11 and the database 20 which is used to register the beneficiary and provide the beneficiary access to the system 100. A beneficiary refers to any individual, group of individuals, entity or group of entities holding an ownership interest, a royalty interest, a leasehold interest, a working interest, or any other type of interest in the mineral interest as previously defined. The beneficiary registration module 120 is intended to grant access to the system to the beneficiary of a mineral interest. The module 120 will record and maintain beneficiary information. The beneficiary registration module 120 may include a beneficiary identification number; the beneficiary's name and address; the name and address of an beneficiary's agent, trustee, designee, administrator, executor, or the like (if applicable); the beneficiary's state and federal tax identification numbers; estate/probate history; escheat history; beneficiary's deposit instructions; and other beneficiary contact information. Other fields may be added hereto as deemed appropriate. In one embodiment of the present invention, the beneficiary registration module 120 may grant a beneficiary full access to all documentation stored within the system related to that beneficiary's interests. In another embodiment of the present invention, the beneficiary registration module 120 may grant a beneficiary limited access to all documentation stored within the system related to that beneficiary's interests. In one embodiment of the present invention, beneficiaries include any and all individuals or entities which have any legal interest in an oil and gas mineral interest.

The system further includes an access control module 130 operatively associated with the server 11 and the database 20 which is used to grant one or more levels of access to owners, depositors and/or beneficiaries to the system 100. In one embodiment of the present invention, the access control module 130 may be used to provide the owner of a mineral interest access to some or all of the documentation and data contained within the system 100 which is associated with the owner's mineral holdings. In another embodiment, the access control module 130 may be used to provide the beneficiary of a mineral interest access to some or all of the documentation and data contained within the system 100 which is associated with the beneficiary's mineral holdings. In yet another embodiment, owners are granted access to all data related to their own oil and gas mineral interest and to all data related to the beneficiaries of the owner's oil and gas mineral interest through the access control module 130. In still another embodiment, beneficiaries are granted access to only the data related to their own oil and gas mineral interest through the access control module 130.

The system further includes a data registration module 140 operatively associated with the server 11 and the database 20 which allows for the registration and storage of any and all data related to an owner's, depositor's or beneficiary's mineral interest. The system and method each utilize the data registration module 140 which allows for the uploading and downloading of any and all oil and gas mineral interest data into the system. The data registration module 140 allows for the collection and storage of data regarding any and all mineral interests held by an owner, depositor and/or a beneficiary. The system and method each provide an access control module 130 which is operatively associated with the computer terminal 10, server 11 and database 20 which is designed to grant one or more levels of access to the owners of the oil and gas mineral interest data. The access control module 130 is also designed to grant one or more levels of access to the beneficiaries of the oil and gas mineral interest data. The data registration module 140 may take in data 142 in electronic form (soft copy), associate that data with one or more owners and/or beneficiaries, and store it within a database 20. The data registration module 140 may take in data 142 as a hard copy (paper), scan or digitize that data, associate that data with one or more owners and/or beneficiaries, and store that data within a database 20. Each piece of data is associated with an owner and or a beneficiary of the oil and gas mineral interest. Each piece of data entered into the system 100 is also granted a standard number and a standard organizational theme using a data standardization module 150 which is operatively associated with the server 11 and the database 20. In one embodiment of the present invention, all data will be scanned, assigned a standard naming convention, digitized into a computer searchable/algorithm searchable format, and placed into one or more databases 20. The data registration module 140 may be used to input data regarding mineral leases, mineral sales, mineral agreements, mineral pricing, mineral transfers, and any other relevant information regarding the acquisition, storage, transfer or sale of minerals and/or mineral interests. A record stored in the database 20 may comprise one or more of the following fields: a standard lease/agreement number; stipulations and provisions; rights and obligations; land descriptions and surveys; polygons and geospatial data; assignments and conveyances; key dates; scanned images and supporting documents; contact information; and cross-references to mineral locations, wells, formations, assets, and related information. Other fields may be added hereto as deemed appropriate. In one embodiment of the present invention, the oil and gas mineral data includes data selected from the group comprising: real property deeds (i.e., general warranty deed, special warranty deed, quitclaim deed and the like), mineral interest related deeds, leases, contracts, operating agreements, pooling/unit agreements, government orders, conveyances, transfers, well records, and the like.

The system further includes a data standardization module 150 operatively associated with the server 11 and the database 20 which grants a standard number and standard organizational theme to a copy of each oil and gas mineral interest entered into the system 100. In the instant invention, the system 100 will utilize a Quick Serial Identifier for Producing Properties (QSIPP) in order to create a standard numbering system that will encompass mineral rights (deeds, leases, and derivative instruments). The QSIPP will uniquely identify many components of real property and oil and gas interests including, but not limited to, contiguous acreage, range of depths, mineral interest, original Depositor, and the originating document.

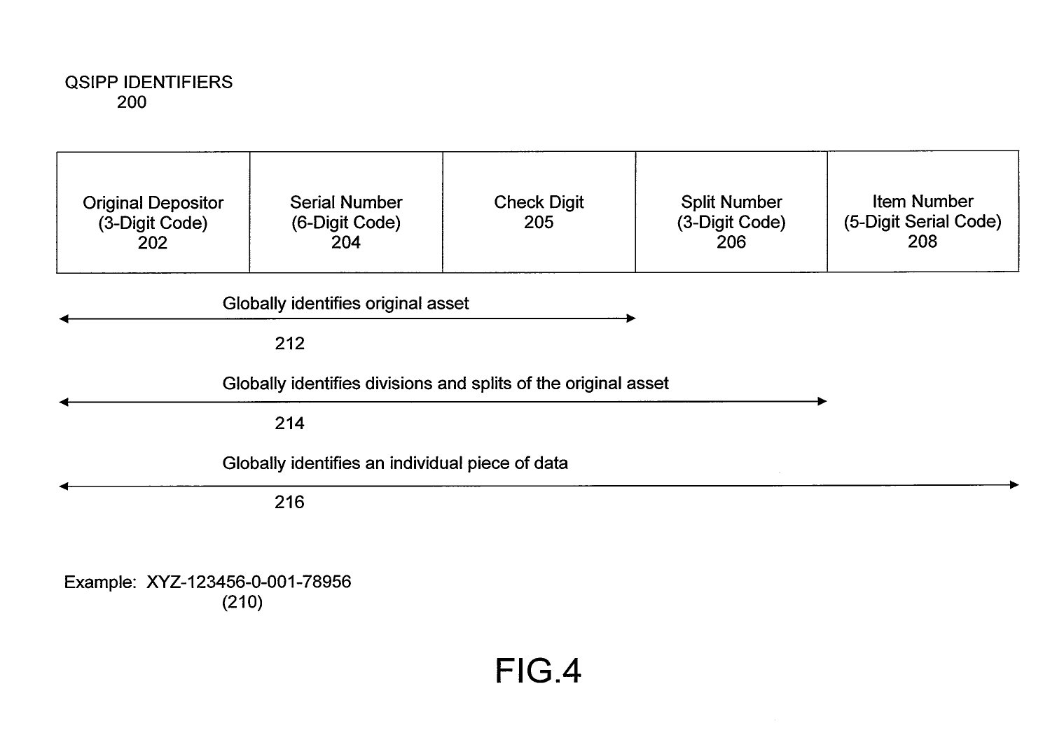

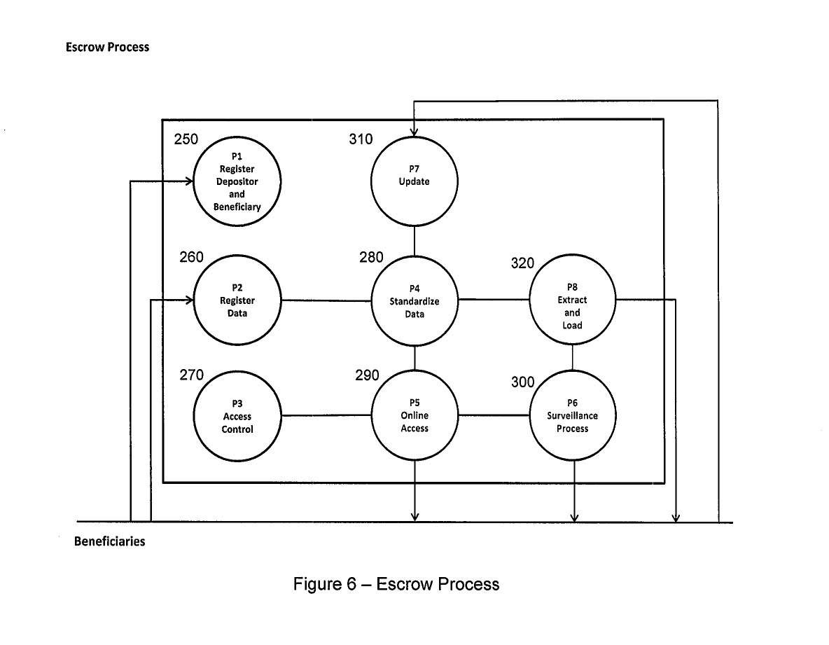

The quick serial identifier for producing properties (QSIPP) globally and uniquely identifies oil and gas assets and the data associated with each asset. The QSIPP generated numbers 200 may be any length and include any desired characters so long as the length and character selection permit the system modules to carry out their designed functions (i.e., the surveillance module 170 and the extract and load module 190 may catalog and locate QSIPP labeled data and documents). Looking to FIG. 4, there is illustrated an embodiment of the QSIPP generated tag 200 from the present invention. QSIPP numbers shall be assigned by a central organization to ensure consistency and precision. As illustrated in FIG. 6, three embodiments may identify:
1) Original Depositor 202, 6-Digit Serial number 204, and check digit 205 are used to globally identify the original assets 212;
2) Original Depositor 202, 6-Digit Serial number 204, check digit 205, and split number 206 are used to globally identify divisions and splits of the original asset 214; or
3) Original Depositor 202, 6-Digit Serial number 204, check digit 205, split number 206, and item number 208 are used to globally identify an individual piece of data such as the digital image of a legal document 216.
   Also illustrated in FIG. 4 is a QSIPP generated code 210. The original depositor 202, as used herein, is a centrally assigned code to identify the individual(s) or entity(ies) that originally deposited the data. The 6-Digit Serial Number 204, as used herein, is a sequentially assigned number that uniquely defines the underlying oil and gas or mineral interest asset. The number shall describe the smallest collection of physical assets with common ownership. The check digit 205, as used herein, is an automatically generated check digit using the “Modulus 10 Double Add Double” technique and is used to maintain the integrity of the asset identifier. To calculate the check digit, every second digit starting from the left, is multiplied by two. Letters are converted to numbers based on their ordinal position in the alphabet. These calculated digits are added together and the least significant digit of the sum is used as the check digit. The split digit 206, as used herein, uniquely identifies derivatives of the oil and gas or mineral interest asset created as the asset is subdivided. Each subdivision would represent variances in ownership of the Oil and Gas asset. Item Number, as used herein, is used to identify an individual piece of data. The Item Number 208 is a 5-Digit sequential number assigned to each piece of data as it is registered.

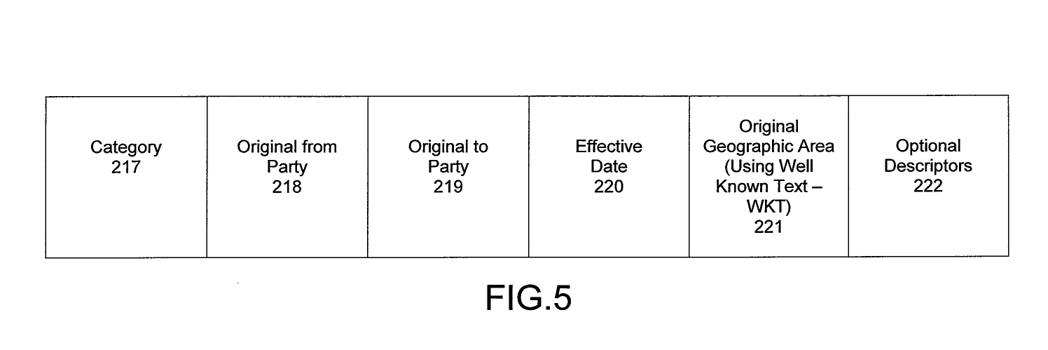

Additionally, the QSIPP may be associated with “Tags” which characterize the code block. The system may include tags which are either mandatory or optional. Looking to FIG. 5 we see illustrated that the required tags include items such as a document category 217 whether a document is an original document from a party or entity 218 or whether a document is an original document from the system which is going out to a party or individual 219. Optional tags may also include assigning an effective date 220 to a document or series of documents. Optional tags may be defined within the system by an administrator or user and include items such as the original geographic area of an interest or deed 221. Well known text (WKT) may be used in some embodiments of the present invention and refers to a text markup language for representing vector geometry objects on a map, spatial reference systems of spatial objects and transformations between spatial reference systems. In another embodiment of the present invention, the binary equivalent of WKT, known as well known binary (WKB) may be used to transfer and store the required and optional information described above within a database. Optional tags may also include optional descriptors 222 which are defined by the depositor or system administrator.

The system 100 further includes an update module 160 operatively associated with the server 11 and the database 20 which allows for the updating of oil and gas mineral interest data 162. The update module allows 160 a user, an owner, a depositor and/or a beneficiary the ability to update the oil and gas mineral interest data 162 to which they have an interest it or access to. The update module 160 may be used to update or refresh oil and gas mineral interest data 162 manually or automatically from remote sensors located in the field. In one embodiment of the present invention, an alert may be issued to the owner and/or the beneficiary of specific oil and gas mineral interest data concerning a change in the status of that data. A change in status may include, but is not limited to, an update of that data, a transfer of that data, a transfer of the legal interest in the real property, a transfer of the legal interest in the mineral rights of a specific piece of real property, or a combination thereof. In one embodiment of the present invention, a user may update mineral data by first scanning a piece of relevant data and uploading the data into the system. The newly uploaded data is then run through the data standardization module 150 wherein the QSIPP program locates and identifies the information relevant to the system and/or relevant to the registered user. All of that data is then cataloged and stored within the system's database 20 and remains searchable and accessible to the owner of the mineral interest and/or the beneficiary of the mineral interest, depending on the level of access granted to that individual/entity by the access control module 130.

The system further includes a surveillance process module 170 operatively associated with the server 11 and the database 20 which allows for the monitoring of owner and/or beneficiary oil and gas mineral interest data. The surveillance process module 170 is operatively associated with the computer terminal 10, servers 11 and database 20 and allows for the monitoring of owner and/or beneficiary oil and gas mineral interest data. The surveillance process module 170 may monitor an owner's or beneficiary's data through data mining or text mining techniques. Text mining, as used herein, refers to the analysis of data contained in natural language text and the process of deriving relevant information from text. Relevant information is typically derived through the devising of patterns and trends through means such as statistical pattern learning. Text mining usually involves the process of structuring the input text (usually parsing, along with the addition of some derived linguistic features and the removal of others, and subsequent insertion into a database), deriving patterns within the structured data, and evaluating and interpreting of the output. Text mining tasks may include text categorization, text clustering, concept/entity extraction, production of granular taxonomies, sentiment analysis, document summarization, and entity relation modeling (i.e., learning relations between named entities). Text analysis may also involve information retrieval, lexical analysis to study word frequency distributions, pattern recognition, tagging/annotation, information extraction, data mining techniques including link and association analysis, visualization, and predictive analytics. Text analytics software may be used to transpose words and phrases in unstructured data into numerical values which can then be linked with structured data in a database and analyzed with traditional data mining techniques. The overarching goal is, essentially, to turn text into data for analysis, via application of natural language processing (NLP) and analytical methods. The surveillance process module 170 may further include functions for data mining which involves exploring and analyzing detailed business transactions. It involves the analysis of anywhere from small amounts of data to vast amounts of data to uncover patterns and relationships contained within a business activity and history. Looking to FIG. 3, there is illustrated an embodiment showing that the surveillance process module 170 may issue an alert 172 when there is any change in an owner's, depositor's and/or beneficiary's data. Also illustrated is that the surveillance process module 170 may issue a warning 174 when there is any change in an owner's, depositor's and/or beneficiary's data which has been defined within the system 100 as having a negative impact to the owner, depositor and/or beneficiary.

The system further includes an online access module 180 operatively associated with the server 11 and the database 20. The online access module 180 is used to grant one or more levels of access to owners 182 and/or beneficiaries 184 to the system 100 from remote locations. A remote location may include any location wherein an owner or a beneficiary who is registered on the system must log into the system through an internet 15 connection. In other words, the connection is not made while in the physical proximity of the system 100. In one embodiment of the present invention, the online access control module 180 may be used to provide the owner of a mineral interest access to some or all of the documentation and data contained within the system 100 which is associated with the owner's mineral holdings. In another embodiment, the online access control module 180 may be used to provide the beneficiary of a mineral interest access to some or all of the documentation and data contained within the system 100 which is associated with the beneficiary's mineral holdings. In still another embodiment, the online access control module 180 may be accessed through an internet browser as described previously. In another embodiment, the online access control module 180 may be accessed via a remote desktop connection.

The system further includes an extract and load module 190. The extraction portion of the extract and load module uses a combination of scripting languages, regular expressions and text/xml/html document parsing to extract relevant information from depositor data 192. The module 190 then transforms the incoming data from the many potential sources into standard data structures. Potential sources include, but are not limited to, land management systems operated by depositors, accounting systems operated by depositors, records management and document management systems operated by depositors, mapping systems operated by depositors, production management systems operated by depositors, third party data subscription services, data from government agencies, or a combination thereof. This data transformation amounts to a particular way of storing and organizing data in a computer so that it may be used in a more efficient manner (i.e. efficient searches, efficient reports, etc.). The standard data structures use dynamic schemas which are implemented using serialized data formats (i.e., JSON, YAML, XML). These data formats often amount to a markup language which defines a set of rules for encoding documents in a format that is both human-readable and machine-readable. A global data dictionary is then used to capture the unique and varied schemas for each data source. This may be regarded as a centralized repository of information about the loaded data 192 and provides definitions as to meaning, relationships to other data, origin, usage and format. Beneficiary extracts 194 may then be obtained from the extract and load module 190. The beneficiary extracts 194 may be defined as data retrieved at the request of a Beneficiary from the Database 20, stored in the standard data format of Data Standardization 150 and for which a Beneficiary has been previously granted access by the Access Control module 130.

The load portion of the extract and load module 190 uses a standard database management system which is a software package including programs which control the creation, maintenance and use of a database 20. The load portion of the module also implements dynamic schemas using serialized data formats inside a relational database management system. The load portion of the module also loads standard data structures (obtained by the extract portion of the module) into one or more of the databases associated with the system. The load portion of the module also may aid in the assignment of QSIPP numbers to all loaded records. The loaded records will have a standard numbering, with flexible schema that preserves the unique data obtained from each source.

By way of example, and in no way limiting the instant invention, a scripting language is a programming language that supports the writing of scripts, programs written for a software environment that automate the execution of tasks which could alternatively be executed one-by-one by a human operator. Environments that can be automated through scripting include software applications, web pages within a web browser, the shells of operating systems, and several general purpose and domain-specific languages such as those for embedded systems. A regular expression provides a concise and flexible means to “match” (specify and recognize) strings of text, such as particular characters, words, or patterns of characters. A regular expression is written in a formal language that can be interpreted by a regular expression processor, which is a program that either serves as a parser generator or examines text and identifies parts that match the provided specification. The following are examples of specifications which can be expressed as a regular expression:
The sequence of characters “car” appearing consecutively, such as in “car”, “cartoon”, or “bicarbonate”
The word “car” when it appears as an isolated word (and delimited from other words, typically through whitespace characters)
The word “car” when preceded by the word “motor” (and separated by a named delimiter, or multiple.)
   Document parsing breaks apart the components (words) of a document or other form of media for insertion into the forward and inverted indices.

Looking again to the Figures below, we see one embodiment of an Escrow Process illustrated in FIG. 6. A summary of the Escrow Process illustrated in FIG. 6 may be described as:
P1. Register Depositor and Beneficiary (250)
   Provide online registration to the Beneficiary including updates, access, and surveillance
   Many to one Beneficiary relationship where one asset may apply to several Beneficiaries
   Makes use of both the owner registration module 110 and the beneficiary registration module 120
P2. Register Data (260)
   Maintain an accurate record of the Depositor's and Beneficiary's data
   Makes use of the data registration module 140
P3. Access Control (270)
   Supply the Depositor/Beneficiary with access to the data through online systems and reports
   Makes use of the access control module 130
P4. Standardize Data (280)
   Grant a standard number and standard organizational theme to a fixed copy of the Beneficiary's data that is placed in escrow
      All data will be scanned, assigned a standard naming convention, digitized into searchable formats, and placed into a single repository
   Makes use of the data standardization module 150
P5. Online Access (290)
   Provide Beneficiary access to their data through the internet.
   Makes use of the online access module 180
P6. Surveillance Process (300)
   Monitor Beneficiary's data through data mining techniques
      Text mining of provisions
      Spatial matching of missing wells by identifying wells within polygons and within a buffered perimeter
   Text pattern analysis for similar text or phrase searches known as time series fingerprinting for oil and gas volumes
      Matches oil & gas volumes with a QSIPP
      Forms a database of aliases to form a text stemming algorithm and a trigram algorithm
      Creates a synthetic production technique
         Takes sales and reconstructs a production curve to allocate sales over a specific time period
         Creates a moving average to smooth the data curve
   Makes use of the surveillance module 150
P7. Update (310)
   Present Beneficiary with options regarding frequency of when data is updated
   Perform routine updates of data with alerts on data changes and detect anomalies
      Levels of service will be specific to negotiated fees
   Makes use of the data update module 160
P8. Extract and Load (320)
   Denote a process in which data is loaded into and extracted from a central, accessible location
   Makes use of the extract and load module 190

The instant invention further includes a method for managing an oil and gas mineral interest comprising the steps of: providing a server 11 and one or more databases 20 operatively associated with the server 11 for storing oil and gas mineral interest data 142; providing one or more computer terminals 10 operatively associated with the server 11 and the database 20; registering an owner of an oil and gas mineral interest through an owner registration module 110 operatively associated with the server 11 and the database 20 to provide the owner access to the system 100; granting one or more levels of access to owners and/or beneficiaries to the system 100 through an access control module 130 operatively associated with the server 11 and the database 20; registering oil and gas mineral interest data using a data registration module 140 operatively associated with the server 11 and the database 20; granting a standard number and standard organizational theme to a copy of each oil and gas mineral interest entered into the system using a data standardization module 150 operatively associated with the server 11 and the database 20; updating the oil and gas mineral interest data using an update module 160 operatively associated with the server 11 and the database 20 which allows for the updating of data loaded into the system with the data registration module 150; and monitoring the owner and/or beneficiary oil and gas mineral interest data using a surveillance process module 170 operatively associated with the server 11 and the database 20.

In one embodiment of the above method, the server 11 is a server selected from the group including an application server, a database server, a file server, a proxy server, a remote access server or a standalone server. In another embodiment of the above method, one or more of the servers 11 is a remote access server which permits a user to access the server 11 and/or the one or more databases 20 operatively associated with the server 11 for storing oil and gas mineral interest data from a remote location over an open or a closed computer network or the Internet 15. In still another embodiment of the above method, the entire system 100 may exist as a cloud computing system. In yet another embodiment of the above method, the oil and gas mineral data 142 includes data selected from the group comprising: real property deeds (i.e., general warranty deed, special warranty deed, quitclaim deed and the like), mineral interest related deeds, leases, operating agreements, pooling/unit agreements, government orders, conveyances, transfers, well records, and the like. In still another embodiment of the above method, beneficiaries include any and all individuals or entities which have any legal interest in an oil and gas mineral interest. In yet another embodiment of the above method, owners are granted access to all data related to their own oil and gas mineral interest and to all data related to the beneficiaries of the owner's oil and gas mineral interest through the access control module 130. In still another embodiment of the above method, beneficiaries are granted access to only the data related to their own oil and gas mineral interest through the access control module 130. In yet another embodiment of the above method, the oil and gas mineral interest data of an owner and/or the oil and gas mineral interest data of a beneficiary may be entered into the system through the use of the data registration module 150.

The above method may further include the step of registering one or more beneficiaries of an oil and gas mineral interest through a beneficiary registration module 120 operatively associated with the server 11 and the database 20 to provide each beneficiary access to the system 100.

The present invention may be embodied in other forms without departing from the spirit and the essential attributes thereof, and, accordingly, reference should be made to the appended claims, rather than to the foregoing specification, as indicating the scope of the invention. The invention illustratively discloses herein suitably may be practiced in the absence of any element which is not specifically disclosed herein.

What is claimed is:

1. A system for tracking and managing oil and gas mineral interest comprising:
a server;
one or more databases operatively associated with said server for storing oil and gas mineral interest data;
one or more computer terminals operatively associated with said server and said database;
an owner registration module operatively associated with said server and said database which is used to register the owner and provide the owner access to the system;
a beneficiary registration module operatively associated with said server and said database which is used to register the beneficiary and provide the beneficiary access to the system;
an access control module operatively associated with said server and said database which is used to grant one or more levels of access to owners and/or beneficiaries to the system;
an oil and gas mineral interest data registration module operatively associated with said server and said database;
a data standardization module operatively associated with said server and said database which grants a standard number and standard organizational theme to a copy of each entry of oil and gas mineral interest data entered into the system;
an update module operatively associated with said server and said database which allows for the updating of oil and gas mineral interest data; and
a surveillance process module operatively associated with said server and said database which allows for the monitoring of owner and/or beneficiary oil and gas mineral interest data.

2. The system of claim 1 wherein said server being a server selected from the group including an application server, a database server, a file server, a proxy server, a remote access server or a standalone server.

3. The system of claim 1 wherein one or more of said servers being a remote access server which permits a user to access the server and/or the one or more databases operatively associated with the server for storing oil and gas mineral interest data from a remote location over an open or a closed computer network or the internet.

4. The system of claim 1 wherein the oil and gas mineral data includes data selected from the group comprising: real property deeds (i.e., general warranty deed, special warranty deed, quitclaim deed and the like), mineral interest related deeds, leases, contracts, operating agreements, pooling/unit agreements, government orders, conveyances, transfers, well records, and the like.

5. The system of claim 1 wherein beneficiaries include any and all individuals or entities which have any legal interest in an oil and gas mineral interest.

6. The system of claim 1 wherein owners are granted access to all data related to their own oil and gas mineral interest and to all data related to the beneficiaries of the owner's oil and gas mineral interest through the access control module.

7. The system of claim 1 wherein beneficiaries are granted access to only the data related to their own oil and gas mineral interest through the access control module.

8. The system of claim 1 wherein the oil and gas mineral interest data of an owner and/or the oil and gas mineral interest data of a beneficiary may be entered into said system through the use of the oil and gas mineral interest data registration module.

9. The system of claim 1 wherein said data standardization module may assign codes for data such as the original beneficiary, the agreement type, the year the agreement was executed, a system generated serial number, a check digit, a split number, or a combination thereof.

10. A method for managing an oil and gas mineral interest comprising the steps of:
providing a server and one or more databases operatively associated with said server for storing oil and gas mineral interest data;
providing one or more computer terminals operatively associated with said server and said database;
registering an owner of an oil and gas mineral interest through an owner registration module operatively associated with said server and said database to provide the owner access to the system;
registering one or more beneficiaries of an oil and gas mineral interest through a beneficiary registration module operatively associated with said server and said database to provide each beneficiary access to the system;
granting one or more levels of access to owners and/or beneficiaries to the system through an access control module operatively associated with said server and said database;
registering oil and gas mineral interest data using an oil and gas mineral interest data registration module operatively associated with said server and said database;
granting a standard number and standard organizational theme to a copy of each entry of oil and gas mineral interest data entered into the system using a data standardization module operatively associated with said server and said database;
updating the oil and gas mineral interest data using an update module operatively associated with said server and said database which allows for the; and
monitoring the owner and/or beneficiary oil and gas mineral interest data using a surveillance process module operatively associated with said server and said database.

11. The method of claim 10 wherein said server being a server selected from the group including an application server, a database server, a file server, a proxy server, a remote access server or a standalone server.

12. The method of claim 10 wherein one or more of said servers being a remote access server which permits a user to access the server and/or the one or more databases operatively associated with the server for storing oil and gas mineral interest data from a remote location over an open or a closed computer network or the internet.

13. The method of claim 10 wherein the oil and gas mineral data includes data selected from the group comprising: real property deeds (i.e., general warranty deed, special warranty deed, quitclaim deed and the like), mineral interest related deeds, leases, operating agreements, pooling/unit agreements, government orders, conveyances, transfers, well records, and the like.

14. The method of claim 10 wherein beneficiaries include any and all individuals or entities which have any legal interest in an oil and gas mineral interest.

15. The method of claim 10 wherein owners are granted access to all data related to their own oil and gas mineral interest and to all data related to the beneficiaries of the owner's oil and gas mineral interest through the access control module.

16. The method of claim 10 wherein beneficiaries are granted access to only the data related to their own oil and gas mineral interest through the access control module.

17. The method of claim 10 wherein the oil and gas mineral interest data of an owner and/or the oil and gas mineral interest data of a beneficiary may be entered into said system through the use of the oil and gas mineral interest data registration module.
